(19) United States
(12) Patent Application Publication
(10) Pub. No.: US 2021/0274890 A1
(43) Pub. Date: Sep. 9, 2021

(54) A LAST DEVICE

(71) Applicant: C. & J. CLARK OVERSEAS LIMITED, Street (GB)

(72) Inventors: Antony PERILLO, Street (GB); Benjamin QUARTLY, Street (GB)

(21) Appl. No.: 17/259,848

(22) PCT Filed: Jun. 21, 2019
(86) PCT No.: PCT/EP2019/066542

§ 371 Date: Jan. 12, 2021

(30) Foreign Application Priority Data
Jul. 13, 2018 (GB) 1811502.2

(51) Int. Cl. A43D 3/04; A43D 3/02

(52) U.S. Cl. CPC A43D 3/04; B33Y 80/00; A43D 3/02

(57) ABSTRACT

Last devices and methods for forming an article of footwear are disclosed. The last device comprises a last body having a surface for receiving material for the article of footwear and at least two sets of fluid conduits extending separately within the last body and opening to the surface of the last body. The at least two sets of separate fluid conduits are provided to subject the material on the last body to at least two different types of treatment. The last body can be produced by means of additive manufacturing.

### FIELD

This disclosure relates to a last device for manufacture of articles of footwear, and methods of manufacture of articles of footwear using the disclosed last device. Methods and apparatuses for manufacture of last devices are also disclosed.

### BACKGROUND

An article of footwear can comprise, e.g., a shoe, sandal, boot or the like or a component of a footwear. Examples of components of footwear comprise an upper and a sole. An upper can be made from various materials, for example leather, different fabrics and textiles and/or synthetic materials and consist of a plurality of material components and layers. A sole is typically made from more hardwearing materials, e.g., rubber and/or hardwearing synthetic materials. Components for footwear can comprise layers of different materials.

Various techniques have been used for producing the shape of footwear. For example, upper material can be placed on a mould and formed into a desired shape by application in succession of moist, heat, and high pressure by a pressing tool. The mould is commonly called a last in the field of shoemaking. The formed upper can then be attached to the sole, for example by means of gluing and/or stitching. Use of lasts in manufacture of articles of footwear can require multiple work stages and be labour intensive, costly and time consuming. Producing required lasts for each line, style and variant of an article of footwear, and also possibly for different stages of making the article of footwear, can also be expensive and laborious, and require specialised tooling.

The embodiments aim to address one or more issues in relation to manufacture of articles of footwear and/or lasts.

### SUMMARY

According to an aspect there is provided a last device for forming an article of footwear, comprising a last body having a surface for receiving material for the article of footwear and at least two sets of fluid conduits extending separately within the last body and opening to the surface of the last body, wherein the at least two sets of separate fluid conduits are provided to subject the material on the last body to at least two different types of treatment.

According to a more specific aspect at least two different types of treatment are applied simultaneously to material on a last body.

The least two separate conduits may be connected to generators of different treatment effects. The treatments may comprise treatment by at least two of pressure, vacuum, hot air, cold air, steam, moist, fluidized powder, and a chemical composition. At least one of the generators may comprise a pump, is a compressor, a steam generator, an air or water cooling unit, an air and water heating unit and/or a reservoir for chemical composition.

A treatment application control arrangement configured for separate control of application of treatments through the at least two fluid conduits may also be provided.

At least a part of fluid conduits can be produced in a last body by means of additive manufacturing. The last body may comprise at least one part of 3D printed material comprising at least one fluid conduit.

A last body may be configured to be separable into at least two parts. At least one of the fluid conduits may extend from one part of the last body to another part of the last body. A sealing arrangement may be provided between the at least two parts.

One set of fluid conduits may open in a first localised area on a surface of a last body. Another set of fluid conduits may open in another localised area on the surface of the last body. The localised areas may provide different types of treatment of the material on the surface.

Two adjacent openings may be arranged to simultaneously provide two different types of treatment in a localised area.

At least one fluid conduit may open towards the side of a last body facing sole section of an article of footwear.

According to another aspect there is provided method for forming in manufacture of an article of footwear, the method comprising placing material for the article of footwear on a surface of a last body comprising at least two sets of fluid conduits extending separately within the last body and opening to the surface of the last body, applying via a first set of the separate fluid conduits a first type of treatment to the material on the surface of the last body, and applying via a second set of the separate fluid conduits a second type of treatment to the material on the surface of the last body.

According to a more specific aspect at least two different types of treatments may be applied simultaneously to material placed on a last body. The least two different types of treatments may be provided by generators of different treatment effects. At least two of pressure, vacuum, hot air, cold air, steam, fluidized powder, and a chemical composition may be applied to material on a last. Solvent may be applied on the material on the last body via at least one of the fluid conduits. Material may be removed, e.g., cut or eroded, from the internal surface thereof by means of the solvent.

A localised treatment of material on a last body may be caused through at least two separate fluid conduits opening to the surface of the last body.

Treatment may be applied to material on a last body via fluid conduits produced by means of additive manufacturing.

A last body may be placed within a piece of material for an article of footwear such that the last body is substantially encompassed by the material.

A last body may be separable into at least two parts. The parts may be inserted one by one within material for an article of footwear and joined so that at least one fluid conduit extends from one part of the last body to another part of the last body.

A different treatment of material on different areas of the surface of a last body may be provided by applying a first type of treatment by one set of fluid conduits opening in a first area on the surface of the last body and applying a second type of treatment by another set of fluid conduits opening in another area on the surface of the last body.

At least a type of treatment may be applied to material that has been placed on a last body on a sole facing side of an upper component of an article of footwear by at least one fluid conduit opening.

Treatment effect generators and/or application of the treatments to material placed on a last body may be controlled by means of a computer program product.

According to a yet further aspect a method for manufacturing a last device for use in forming an article of footwear is provided. The method comprises producing by means of additive manufacturing a last body comprising a surface for receiving material for the article of footwear and at least two sets of fluid conduits extending within the last body and opening to the surface of the last body, the producing process comprising forming the at least two sets of fluid conduits as separated flow systems for facilitating simultaneous application of at least two different types of treatment to the material on the surface of the last body.

3D printing may be used to produce at least a part of a last body comprising a complex pattern of fluid conduits.

An article of footwear manufactured according to herein described methods and devices may also be provided.

### BRIEF DESCRIPTION OF DRAWINGS

Various exemplifying embodiments of the invention are described below with reference to the attached drawings. Steps and elements explained herein may be reordered, omitted, and combined to form different embodiments and any step indicated as performed may be caused to be performed in another order. In the drawings:

FIGS. 1 and 2 are perspective views of an example of a last device;

FIGS. 3 and 4 are sectioned views of certain details of a last device;

FIG. 5 shows a detail of the last device of FIGS. 1 and 2;

FIG. 6 shows apparatus for generating treatments effects;

FIG. 7 shows a last device split into two according to an embodiment;

FIGS. 8A, 8B, and 8C show an example related to additive manufacturing by 3D printing;

FIGS. 9 and 10 are flowcharts according to certain embodiments; and

FIG. 11 shows a control apparatus.

### DETAILED DESCRIPTION

In the following certain detailed examples in relation to last devices for use in manufacture of articles of footwear embodying the invention will be described with reference to the appended drawings.

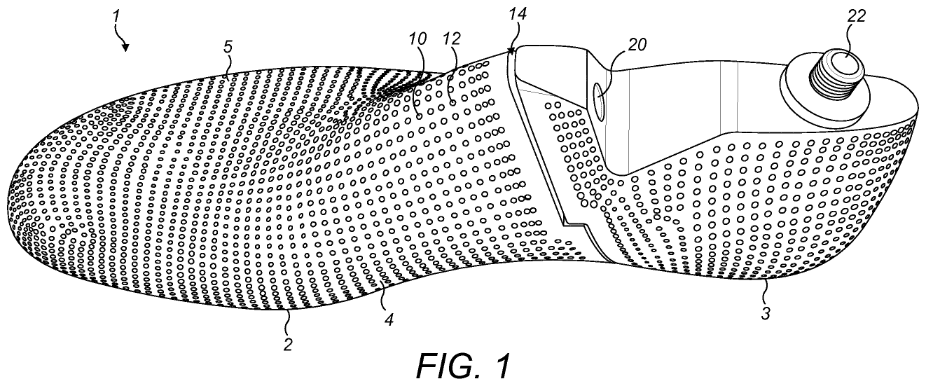

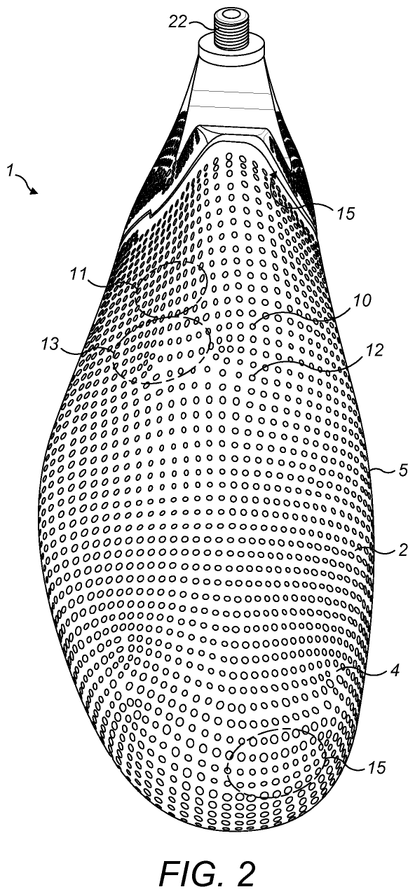

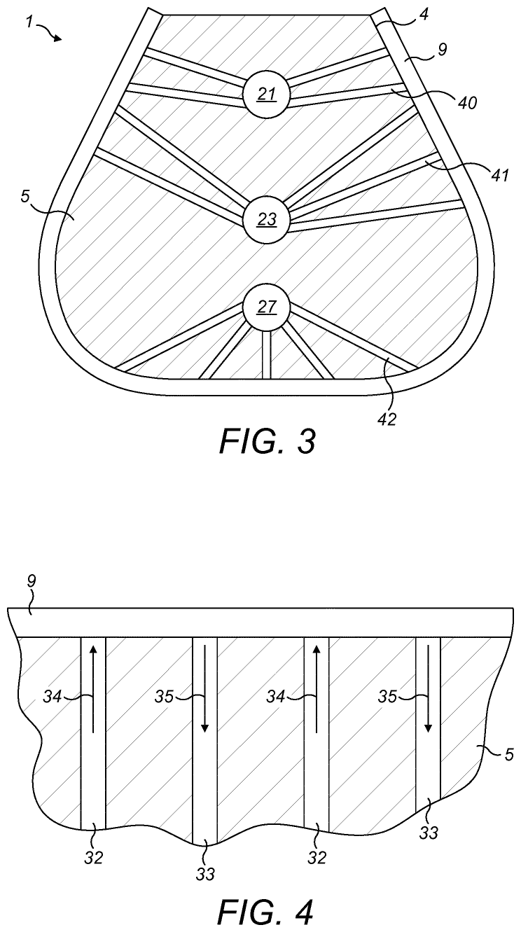

FIGS. 1 and 2 show perspective views and FIGS. 3 and 4 show cross sectioned views of a perforated or porous last device 1 according to certain examples. The term “last” is a specific term typically used for a mould used for making articles of footwear. A last can be seen as an approximate static model of the human foot with features that dictate the shape and style of an article of footwear. Lasts have been conventionally made, e.g., from plastic, wood or metal on which shoes are shaped during manufacture and repair of shoes. Lasts typically come in pairs. The design of a new shoe or the like often involves design and production of several new pairs of lasts.

The last device 1 comprises a body block 5 having a surface 4 for receiving material 9 to be shaped for the article of footwear. At least two sets of fluid conduits or manifolds extend separately within the last body 5 such that the holes at the ends of the conduits or manifolds open to the surface of the last body. The conduits are not visible in FIGS. 1 and 2, examples of sets of fluid conduits 40, 41 and 42 provided in the last body 5 being shown in FIGS. 3 and 4.

The conduits within the last material can be complex in structure. Such complex structures are made possible by advanced manufacturing techniques. A possibility is to use additive manufacturing for producing a last. Examples of possible additive techniques are described later in this description.

Substantially the entire surface 4 of the last body is shown to be covered by openings 10, 12 in FIGS. 1 and 2. It is also possible to provide the openings only on a part or certain parts of the last body surface. The size, shape and positioning of the openings can be optimised according to the requirements of the materials used and footwear to be made.

The at least two sets of separate fluid conduits are arranged to subject the material 9 disposed on the surface 4 of last body 5 to at least two different types of treatment. Treatments can be provided for example for shaping, forming, cutting, eroding, softening, hardening and/or otherwise conditioning to the material for article of footwear. More detailed examples of possible treatments will be explained below.

The last device 1 can be configured to apply the at least two different types of treatment simultaneously to material placed on the last body. The different treatments can be applied in different areas. This is illustrated in FIG. 2 where a set of the fluid conduits opens in a first localised area 11 on the surface of the last body. Other sets of the fluid conduits may then open in other localised areas 13 and 15 on the surface of the last body. The localised areas can be arranged to provide different types of treatment of the material on the surface 4.

Different types of treatment can also be provided in an area by nearby openings. This is illustrated in FIG. 4 of a last body 5 where fluid conduits 33 draw material 9 on the surface of the last body by suction 35 and the adjacent fluid conduits 32 treat the material 9 on the last body by applying e.g. moist, heat, cooling, or treatment by a chemical composition to the material 9.

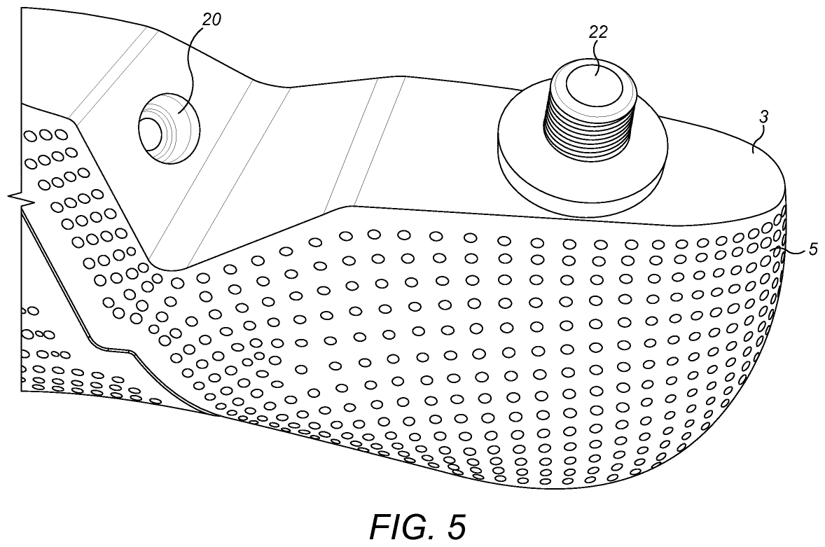

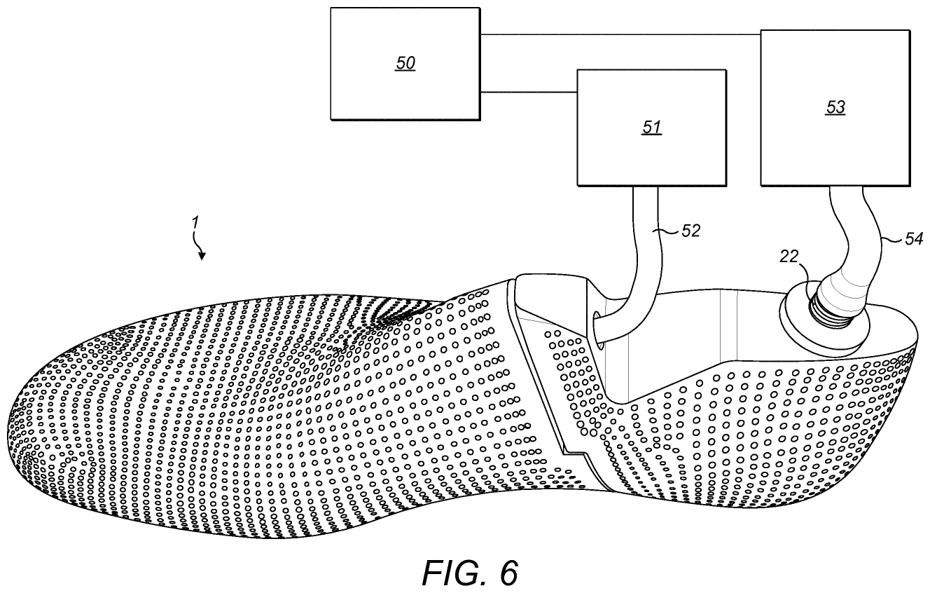

The separate fluid conduits for different types of fluid treatments can be supplied by wider supply channels 21 and 23, as shown e.g. in FIG. 3. The supply channels can be provided with connectors, for example connectors 20, 22 as shown in FIG. 5, to connect the fluid conduits to external fluid effect generators. FIG. 6 illustrates an example of connecting arrangements where connectors 20 and 22 on the last body 5 are arranged to connect two sets of fluid conduits to fluid effect generating apparatus 51, 53 via hoses 52, 54. Operation and the effects caused by the generator apparatus can be controlled by control apparatus 50.

The at least two separate sets of conduits can be connected to the generators 51 and 52 facilitating application of different types of treatment effects to the material on the last device. For example, generator apparatus can generate one or more of air or water pressure, vacuum, hot air, cold air, steam and moist. Treatment by a chemical composition such as a by treatment composition, resin, adhesive, solvent and/or cement for shoemaking can also be provided. For example, at least one of the conduits can be used to treat the material by application of solvent such as corrosive or eroding fluid on the material so as to cut or remove material on a desired location on the last. Material hardening and/or softening chemical may also be applied locally. At least one of the generators can comprise a pump, a compressor, a steam generator, a cooling unit for air, water, fluidized powder or other fluid, a heating unit for air, water or other fluid and/or a treatment composition reservoir and/or pump.

The generators can be controlled by the control apparatus 50 such that the at least two separate fluid conduits extending between the generators and the openings on the surface of the last body are separately operable. The control apparatus can comprise appropriate hardware and software components, user interface(s), connections and so forth to provide the required control functions. Examples of features controlled comprise flow rate, pressure, temperature, selection of treatment composition. The control can take into account feedback from the workpiece on the last device, for example feedback information generated based on a machine vision, infrared, laser or another sensing arrangement and adapt the operation of the generator apparatus accordingly.

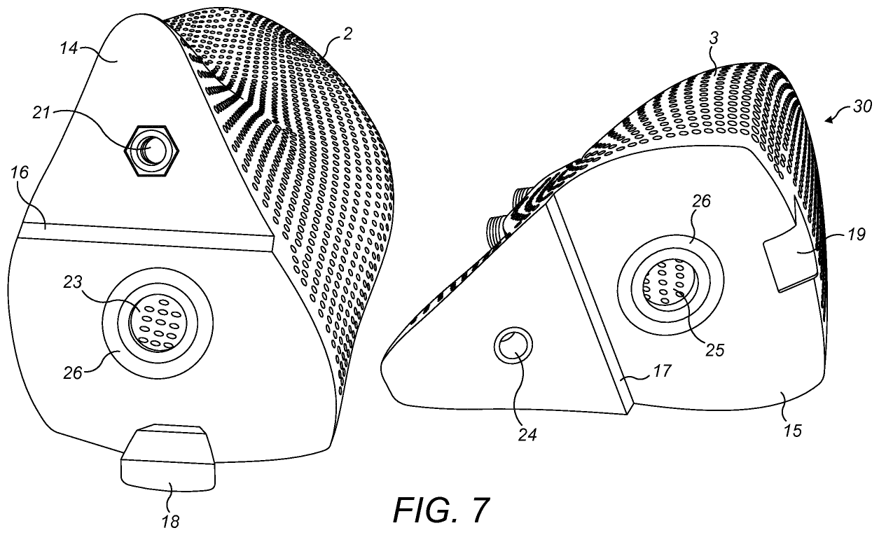

FIG. 7 illustrates an embodiment where the last body is separable into at least two parts 2 and 3. Separable last device may be desired, e.g., for enabling insertion into and removal from an enclosed upper or shoe material piece. When the last parts are joined together at least one fluid conduit within the last body block can extend from one part of the last body to another part of the last body. In FIG. 7 channel 25 of part 3 continues as channel 23 in part 2, and channel 24 of part 3 continues as channel 21 in part 2. Sealing arrangement 26 can be provided between the two parts 2 and 3 to prevent fluid within the channels from escaping when the faces 14 and 15 are pressed together. The alignment of the parts 2 and 3 can be ensured by co-operative guide formations 16, 17 and 18, 19.

FIG. 7 illustrates also the possibility of at least one fluid conduit opening towards the bottom side 30 of the last body, the bottom side being the side facing the sole of an article of footwear. This feature can also be seen in to FIG. 3 where the set of fluid conduits 42 supplied by channel 27 open towards the bottom of the last block.

The last device can be attached to robotic arm. For example, the last device can be moved between workstations and/or between a workstation and a last storage and/or during footwear formation process by a robot. The last device can be inserted within upper material to be treated and removed from treated upper component by means of the robot, or another manipulator operated under control of an appropriate computer program product.

At least a part of the fluid conduits can be produced in the last body by means of additive manufacturing at the time of producing the perforated last device by means of additive manufacturing. An example of additive manufacturing techniques is three dimensional (3D) printing and at least one part of the last device can comprise 3D printed material. 3D printing is an additive process where material is laid down by progressively adding material to form a product of desired shape, size and appearance. In this specification term ‘3D printing’ is used to refer to additive manufacturing processes that can be used to create physical objects from three dimensional digital data.

The additive manufacturing processes can be arranged to re-form a raw material by the addition of energy and positioning in a controlled manner. The control is provided by an appropriate control unit based on the digital data. The inventors have found that 3D printing facilitates manufacture of last devices with complex geometries required by at least some of the herein described fluid conduit arrangements comprises separated sets of fluid conduits.

A variety of 3D printing processes are available. Also, a variety of stock materials (polymers, metals, ceramics, etc.) in differing forms (e.g. liquids, powders, granules, and filament) are available. According to a possibility the material comprises 3D printed material that has been infused with epoxy resin. An example of such materials and techniques is disclosed in GB patent 2512355B.

The material to be used for 3D printing or moulding of a last body can be selected to have such properties that no separate curing process after printing or moulding is necessary. That is, after e.g. 3D printing the printed portion can be left to cool and settle without the need to use any curing agent. This is possible by appropriate selection of the printing material. The material can be in semi-liquid state at the time of printing, and adapted to bond mechanically and chemically with other material.

The additive process, such as operation and movement of a 3D print head relative to the component to be manufactured, and/or movement of a support on which the printing takes place, can be controlled by one or more controller units.

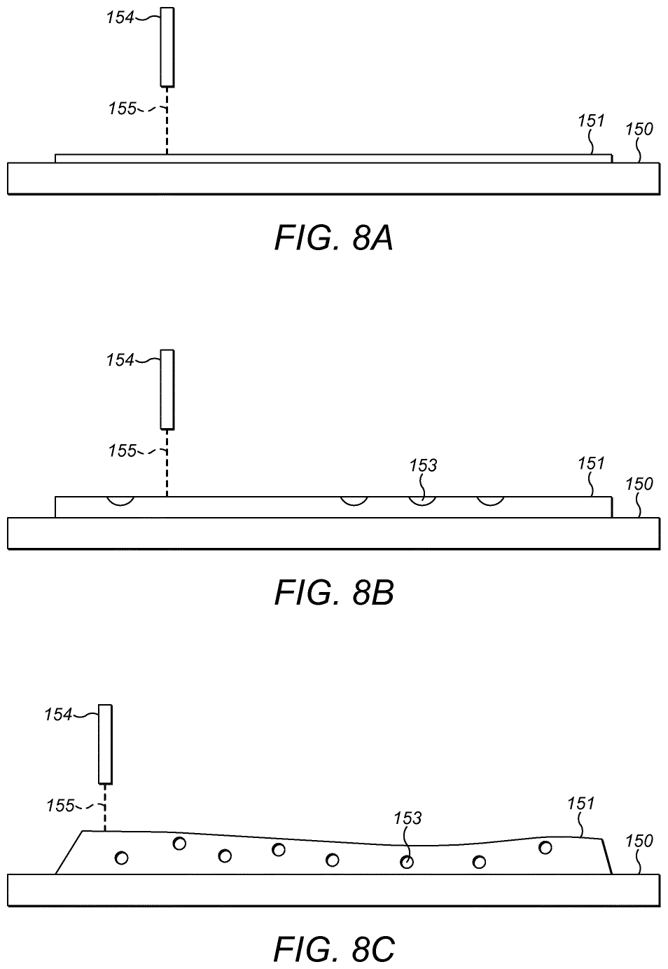

An example of 3D printing on a substrate provided by a component of the footwear is illustrated in FIGS. 8A, 8B and 8C. In FIG. 8A a 3D print head 154 has just started to lay down a first thin layer of material 155 on a printing platform 150. The platform may, in certain applications, be shaped according to the requirements of the final product. In FIG. 8B the thickness of the added material 155 has grown to a thickness where first fluid conduit openings 153 are to be formed. FIG. 8C illustrates some already finished openings 153 of the fluid conduits. FIG. 8C also illustrates how the print head 154 can add material 155 only in areas of the last device body that are thicker than the rest of the device. The print head 154 can be operated such that material 155 is layered on to the substrate 150 in appropriate angles. The print head can be arranged to operate in e.g. a 5-axis or 7-axis control system. The operation of the printing head can be controlled by an appropriate combination of control apparatus and software. A last device body may be completely 3D printed. In other embodiments, depending on the requirements, the majority of the body is produced by 3D printing.

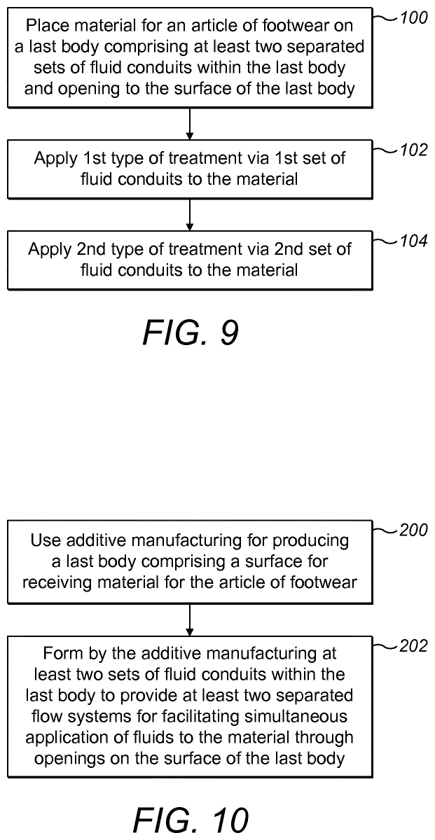

FIG. 9 is a flowchart according to an embodiment of forming at least a part of an article of footwear. In the method, material for the article of footwear is placed at 100 on a surface of a last body, the last body comprising at least two sets of fluid conduits extending separately within the last body and opening to the surface of the last body. A first type of treatment is then applied at 102 to the material on the surface of the last body via a first set of fluid conduits and through the openings. A second type of treatment is applied at 104 to the material on the surface of the last body via a second set of fluid conduits and through the openings.

At least two different types of treatments may be applied simultaneously to the material on the last body. At least two different types of treatments can be generated by different types of generators of treatment effects.

Localised treatment of the material can be provided through the at least two separate fluid conduits and openings on the surface of the last body.

According to an embodiment the last body is inserted within a piece of material for the article of footwear such that the last body is substantially encompassed by the material. The last body may be separated into at least two parts. The parts can then be inserted one by one within the material for the article of footwear and joined so that at least one of the fluid conduits extends from one part of the last body to another part of the last body.

Different treatment of the material may be provided on different areas of the surface of the last body by applying a first type of treatment by one set of fluid conduits opening in a first area on the surface of the last body and applying a second type of treatment by another set of fluid conduits opening in an another area on the surface of the last body.

At least a type of treatment may be applied to material that has been placed on the last body on the sole facing side of an upper component of the article of footwear by at least one fluid conduit opening.

A treatment can comprise removal of material e.g. by cutting or eroding material placed on the last. At least one of the conduits can be used to apply solvent, for example corrosive or material eroding fluid on the material so as to cut or remove material on one or more locations on the last. This can be provided, e.g., to make an internal cut on the material, or remove a layer, a part of a layer, or several layers of a multilayer material on the last. Material hardening and/or softening agent may also be applied locally.

Flowchart of FIG. 10 shows a method for manufacturing a last device for use in forming an article of footwear. The method comprises producing at 200, by means of additive manufacturing a last body comprising a surface for receiving material for the article of footwear and at least two sets of fluid conduits extending within the last body and opening to the surface of the last body. The process comprises at 202 forming the at least two sets of fluid conduits as separated flow systems for facilitating simultaneous application of at least two different types of treatment to the material on the surface of the last body. The additive manufacturing can comprise 3D printing at least a part of a last body comprising a complex pattern of fluid conduits.

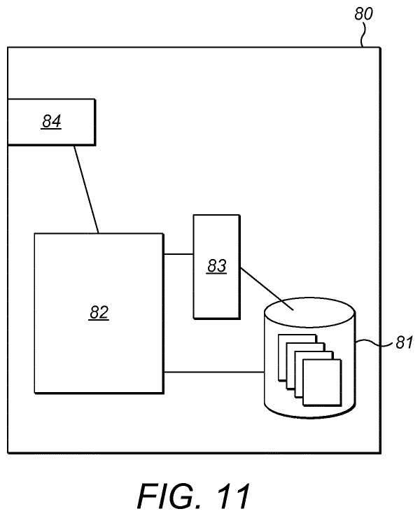

FIG. 11 shows an example of control apparatus. The control apparatus 80 can be for example integrated with, coupled to and/or otherwise controlling a 3D printing apparatus, a robot, and/or treatment effect generator apparatus. For this purpose the control apparatus comprises at least one memory 81, at least one data processing unit 82, 83, and an input/output interface 84. Via the interface the control apparatus can be coupled to the devices it is indented to control and/or a communication system for communication with other data processing apparatus, for example a manufacturing, measurement data, stock management control system and so forth. The control apparatus can be configured to execute an appropriate software code to provide control functions required by processes described herein.

In accordance with a possibility a computer program product has be configured to control application of treatments on material for an article of footwear placed on a surface of a last body comprising at least two sets of fluid conduits extending separately within the last body and opening to the surface of the last body. The software product can be arranged to control application, via a first set of the separate fluid conduits, of a first type of treatment to the material on the surface of the last body and application, via a second set of the separate fluid conduits, of a second type of treatment to the material on the surface of the last body. The above describes other examples of possible aspects that can be controlled by means of the computer program product.

While certain aspects of the invention may be illustrated and described as block diagrams, flow charts, or using some other schematic pictorial representation, it is well understood that these blocks, apparatus, systems, techniques and control methods described herein may be implemented in, as non-limiting examples, hardware, software, firmware, special purpose circuits or logic, general purpose hardware or controller or other computing devices, or some combination thereof.

The foregoing description provides by way of exemplary and non-limiting examples a full and informative description of exemplary embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the spirit and scope of this invention.

1. A last device for forming an article of footwear, comprising:
a last body having a surface for receiving material for the article of footwear and at least two sets of separate fluid conduits extending separately within the last body and opening to the surface of the last body, wherein the at least two sets of separate fluid conduits are configured to apply at least two different treatments simultaneously to the material on the last body.

2. (canceled)

3. The last device according to claim 1, wherein the least two sets of separate fluid conduits are connected to generators of different treatment effects.

4. The last device according to claim 3, wherein the treatments comprise treatment by at least two of pressure, vacuum, hot air, cold air, steam, moist, fluidized powder, and a chemical composition.

5. The last device according to claim 3, wherein at least one of the generators comprises a pump, a compressor, a steam generator, an air or water cooling unit, an air or water heating unit or a reservoir for chemical composition.

6. The last device according to claim 1, comprising a treatment application control arrangement configured for separate control of application of treatments through the at least two sets of fluid conduits.

7. The last device according to claim 1, wherein at least a part of the fluid conduits are produced in the last body by additive manufacturing.

8. The last device according to claim 7, wherein the last body comprises at least one part of 3D printed material comprising at least one fluid conduit.

9. The last device according to claim 1, wherein the last body is separable into at least two parts and at least one of the fluid conduits extends from one part of the last body to another part of the last body.

10. The last device according to claim 9, comprising a sealing arrangement between the at least two parts.

11. A last device for forming an article of footwear, comprising:
a last body having a surface for receiving material for the article of footwear and at least two sets of fluid conduits extending separately within the last body and opening to the surface of the last body, wherein the at least two sets of separate fluid conduits are provided to subject the material on the last body to at least two different treatments and wherein one set of the fluid conduits opens in a first localized area on the surface of the last body and another set of the fluid conduits opens in another localized area on the surface of the last body, the localized areas providing different types of treatment of the material on the surface.

12. The last device according to claim 11, wherein two adjacent openings are configured to provide simultaneously two different types of treatment in a localized area.

13. The last device according to claim 1, comprising at least one fluid conduit opening towards the side of the last body facing a sole section of the article of footwear.

14. A method for forming in manufacture of an article of footwear, the method comprising:
placing material for the article of footwear on a surface of a last body comprising at least two sets of separate fluid conduits extending separately within the last body and opening to the surface of the last body;
applying via a first set of the separate fluid conduits a first type of treatment to the material on the surface of the last body; and
applying simultaneously via a second set of the separate fluid conduits a second type of treatment to the material on the surface of the last body.

15. (canceled)

16. The method according to claim 14, comprising producing the least two different types of treatments by generators of different treatment effects.

17. The method according to claim 14, comprising applying at least two of pressure, vacuum, hot air, cold air, steam, fluidized powder, and a chemical composition to the material.

18. The method according to claim 14, comprising causing localized treatment of the material through the at least two separate fluid conduits opening to the surface of the last body.

19. The method according to claim 14, comprising applying solvent on the material on the last body via at least one of the fluid conduits.

20. The method according to claim 14, comprising applying treatment to the material via fluid conduits produced by means of additive manufacturing.

21. The method according to claim 14, comprising placing the last body within a piece of material for the article of footwear such that the last body is substantially encompassed by the material.

22. The method according to claim 14, comprising separating the last body into at least two parts, inserting the at least two parts one by one within material for the article of footwear, and joining the at least two parts so that at least one of the fluid conduits extends from one part of the last body to another part of the last body.

23. The method according to claim 14, comprising providing a different treatment of the material on different areas of the surface of the last body by applying the first type of treatment by one set of fluid conduits opening in a first area on the surface of the last body and applying a second type of treatment by another set of fluid conduits opening in another area on the surface of the last body.

24. The method according to claim 14, comprising applying at least a type of treatment to the material that has been placed on the last body on the sole facing side of an upper component of the article of footwear by at least one fluid conduit opening.

25. A method for manufacturing a last device for use in forming an article of footwear, the method comprising producing by additive manufacturing a last body comprising a surface for receiving material for the article of footwear and at least two sets of fluid conduits extending within the last body and opening to the surface of the last body, the process comprising forming the at least two sets of fluid conduits as separated flow systems for facilitating simultaneous application of at least two different types of treatment to the material on the surface of the last body.

26. The method according to claim 25, comprising 3D printing at least a part of a last body comprising a complex pattern of fluid conduits.

27. An article of footwear manufactured according to a method for forming an article of footwear using a last device comprising a last body having a surface for receiving material for the article of footwear and at least two sets of fluid conduits extending separately within the last body and opening to the surface of the last body, wherein a first type of treatment and second type of treatment have been applied simultaneously to the material on the surface of the last body via a first set of the fluid conduits and a second set of the fluid conduits.
